(19) United States
(12) Patent Application Publication
(10) Pub. No.: US 2026/0201651 A1
(43) Pub. Date: Jul. 16, 2026

(54) METHOD FOR MANUFACTURING A CELLULOSE-BASED LAMINATE COMPRISING A MINERAL-BASED LAYER

(71) Applicant: Stora Enso OYJ, Helsinki (FI)

(72) Inventors: Kaj Backfolk, Lappeenranta (FI); Isto Heiskanen, Imatra (FI)

(73) Assignee: Stora Enso OYJ, Helsinki (FI)

(21) Appl. No.: 19/127,936

(22) PCT Filed: Sep. 14, 2023
(86) PCT No.: PCT/IB2023/059130

§ 371 Date: May 7, 2025

(30) Foreign Application Priority Data
Nov. 18, 2022 (SE) 2230375-4

(51) Int. Cl. D21H 27/30; D21H 19/72

(52) U.S. Cl. CPC D21H 27/30; D21H 19/72

(57) ABSTRACT

The present invention relates to a method for manufacturing a cellulose-based laminate comprising a mineral-based layer in a paper-making machine, the method comprising: a) forming a first web layer on a first wire; b) forming a second web layer comprising 60-95% by dry weight of a particulate mineral and 5-40% by dry weight of a binder, on a second wire; and c) laminating the second web layer and the first web layer to obtain a laminate web; and d) dewatering, and optionally drying, the formed laminate web to obtain a cellulose-based laminate comprising a mineral-based layer.

### TECHNICAL FIELD

The present disclosure relates to methods for manufacturing paper and paperboard comprising a mineral-based layer.

### BACKGROUND

Many paper and paperboard products are provided with a mineral-coated surface to give desirable properties such as whiteness, brightness, gloss, and/or high-quality print. Typical coating components include pigments, binders, additives, and water. Commonly used pigments include calcium carbonate, talc, titanium dioxide, and/or kaolin clay. As binder, a styrene-butadiene latex, styrene-acrylate latex, vinylacetate latex, vinylacetate-acrylate latex, carboxymethyl cellulose, and/or starch can be utilized. Examples of other additives include insolubilizers, lubricants, defoamers, thickening agents, co-binders, stabilizers, and optical brightening agents (OBAs).

Mineral-coated paper or paperboard, also commonly referred to as white top liner or white top paper or paperboard, is typically made either by adding a particulate mineral to the top ply of a multiply paper or paperboard via the headbox, or by coating the paper or paperboard product with a coating composition comprising the particulate mineral and a binder.

Applying the particulate mineral to the top ply of a multiply paper or paperboard via the headbox severely restricts the amount of particulate mineral that can be added. The amount of particulate mineral that can be applied by this method is typically limited to <10% by dry weight of the top ply, since the addition of the particulate mineral also affects stiffness, strength and retention.

Applying the particulate mineral to the paper or paperboard product by coating with a coating composition comprising the particulate mineral and a binder often limits the coat weight to a relatively narrow range, since at low coat weight (typically <5 g/m²), the coating coverage becomes sensitive to base substrate properties, coating formulation and the coating conditions. If using other types of additives, such as fibrils and fiber fragments, these cause challenges to flow behavior and will often cause problems with runnability when levelling the coating dispersion. At high coat weights (typically >10 g/m²), the amount of water applied will also be high, leading to problems with dewatering, drying and rewetting of the paper or paperboard substrate.

From a technical and economical point of view, it would be preferable to find a solution that enables manufacturing of a cellulose-based laminate comprising a mineral-based layer, without the inherent drawbacks and limitations of the existing coating methods.

### DESCRIPTION OF THE INVENTION

It is an object of the present disclosure to provide a method for manufacturing paper and paperboard comprising a mineral-based layer, which alleviates at least some of the above-mentioned problems associated with prior art methods.

It is a further object of the present disclosure to provide an improved method for manufacturing paper and paperboard comprising a mineral-based layer in a paper-or paperboard machine type of process.

It is a further object of the present disclosure to provide an improved method for manufacturing a paper and paperboard comprising a mineral-based layer in a paper-or paperboard machine type of process, wherein the grammage and composition of the mineral-based layer can be selected independently of the cellulose-based layer.

The above-mentioned objects, as well as other objects as will be realized by the skilled person in the light of the present disclosure, are achieved by the various aspects of the present disclosure.

The inventive method allows for efficient manufacturing of a paper and paperboard comprising a mineral-based layer, also referred to as white top liner or white top paper or paperboard, in a paper machine type of process. The method can be used to replace conventional mineral coating methods. The method allows for good mineral coverage to be achieved with relatively low grammage of the mineral-based layer, such as in the range of 10-30 gsm or even 10-15 gsm, also using particulate minerals having smaller particle sizes.

According to a first aspect illustrated herein, there is provided a method for manufacturing a cellulose-based laminate comprising a mineral-based layer in a paper-making machine, the method comprising:
a) forming a first web layer by applying a first suspension comprising at least 50% by dry weight of cellulose-based fibrous material having a Schopper-Riegler (SR) value in the range of 18-50 on a first wire, and partially dewatering the first web layer on the first wire;
b) forming a second web layer by applying a second suspension comprising
60-95% by dry weight of a particulate mineral and
5-40% by dry weight of a binder, wherein said binder is a highly refined cellulose (HRC) having an SR value in the range of 75-100,
on a second wire, and partially dewatering the second web layer on the second wire,
wherein the second suspension has a dry solids content of at least 0.5 wt % and the second suspension is applied directly on the second wire using a curtain applicator;
c) laminating the partially dewatered second web layer and the partially dewatered first web layer to obtain a laminate web; and
d) dewatering, and optionally drying, the formed laminate web to obtain a cellulose-based laminate comprising a mineral-based layer.

The term “web” or “web layer” as used herein refers to a sheet formed material obtained by applying a suspension comprising a dispersed solid material (e.g. a cellulose-based fibrous material, a highly refined cellulose, or a particulate mineral) on a surface, preferably a porous surface, and at least partially dewatering the applied suspension to increase the dry solids content of the suspension until a web layer is formed on the surface.

The term cellulose-based laminate as used herein refers generally to a multilayer sheet formed material obtained by lamination of a cellulose-based web layer and one or more other layers. Depending on the thickness and composition of the cellulose-based laminate, it can be considered as a multiply paper or a paperboard.

The term mineral-based layer refers to the layer formed from the second suspension.

The cellulose-based laminate can be used as such, or it can be combined with one or more other layers. The cellulose-based laminate may for example be useful as a paper or paperboard-based packaging material

Although different arrangements for performing the steps of the inventive method could be contemplated by the skilled person, the inventive method may advantageously be performed in a paper machine, more preferably in a Fourdrinier type paper machine, i.e. a paper machine based on based on the principles of the Fourdrinier Machine.

An advantage with the inventive method is that it is easy to implement on an existing paper or paperboard machine by simply adding a second wire section. The added wire section does not require a headbox or a large water circulation system. Alternatively, the inventive method can be run on an existing multiply machine, having two or more wires by simply shutting down the headbox and adding or running an existing curtain applicator on one of the wires.

Traditional headboxes limit the use of higher dry solids content when running suspensions having high content of particulate mineral and highly refined pulp. A normal headbox can run such suspensions at consistencies up to a maximum of about 0.5 wt %, depending on suspension viscosity and flow behavior. Using a curtain applicator, the consistency, and/or viscosity, of the applied suspensions could, and should, be significantly higher. The high consistency of the applied suspensions means that less water has to be removed during dewatering, and in turn that the short circulation can be made significantly smaller. A further advantage of the inventive method wherein the web layers are formed on different wires is that different additives can be utilized in the different suspensions, and chemicals and other additives that would normally not be suitable for use in one type of suspension may be used solely in the other suspension.

A paper machine (or paper-making machine) is an industrial machine which is used in the pulp and paper industry to create paper or fiber-based substrates in large quantities at high speed. Modern paper-making machines are typically based on the principles of the Fourdrinier machine, which uses a moving dewatering fabric or woven mesh, commonly referred to as a “wire”, to create a continuous web by filtering out the fibers held in a pulp suspension and producing a continuously moving wet web of fiber. This wet web is dried in the machine to produce paper or film.

The forming and dewatering steps of the inventive method are preferably performed at the forming section of the paper machine, also commonly referred to as the wet end.

The wet web layers are formed on different wires in the forming section of the paper machine. The preferred type of forming section for use with the present invention includes at least two wires. The wires are preferably endless wires. The dewatering fabric of the wires can be a single ply or multiply fabric, made of plastic, non-woven, composite, or metal. The first wire can be any of those known to a person skilled in the art for use in paper or paperboard manufacturing. The second wire may be selected to provide a combination of an acceptable dewatering rate and retention of the particulate mineral and highly refined cellulose. The second wire used in the inventive method preferably has an air permeability in the range of 2000-7000 m³/m²/hour at 100 Pa, more preferably in the range of 2500-5500 m³/m²/hour at 100 Pa. The second wire used in the inventive method preferably has relatively high porosity in order to allow fast dewatering and high drainage capacity. The second wire preferably has a high fibre support index (F.S.I), typically above 190 so that fine material does not penetrate into the structure and to cause less wire markings, and a coarse and open back side. The wire section of a paper machine may have various dewatering devices such as blade, table and/or foil elements, suction boxes, friction less dewatering, ultra-sound assisted dewatering, couch rolls, or a dandy roll.

In the inventive method a first web layer and a second web layer are formed separately by applying a first suspension comprising at least 50% by dry weight of cellulose-based fibrous material having a Schopper-Riegler (SR) value in the range of 18-50 on a first wire, and partially dewatering the first web layer on the first wire, and by applying a second suspension comprising 60-95% by dry weight of a particulate mineral and 5-40% by dry weight of a binder, wherein said binder is a highly refined cellulose (HRC) having an SR value in the range of 75-100, on a second wire, and partially dewatering the second web layer on the second wire.

The partially dewatered second web layer and the partially dewatered first web layer are then laminated to obtain a laminate web, and the laminate web is then dewatered and optionally dried to obtain a cellulose-based laminate comprising a mineral-based layer.

The first web layer comprising relatively easy to dewater cellulose-based fibrous material having a Schopper-Riegler (SR) value in the range of 18-50 may be prepared by any suitable method, the most common involving application of the first suspension at a dry solids content well below 1.5 wt %, and typically below 0.5 wt %, onto the first wire using a so-called headbox.

The second suspension comprising at least 50% by dry weight of the significantly more difficult to dewater particulate mineral and highly refined cellulose (HRC) is applied to the wire at a dry solids content of at least 0.5 wt %. Suspensions having high content of particulate mineral and HRC and having such a high dry solids content are not suited for being applied using a headbox due to high viscosities and tendencies of the HRC to form gels, and the second suspension is therefore instead applied using a so-called curtain applicator.

A curtain applicator, also sometimes referred to as curtain coater or wet end applicator, transfers a thin film of falling liquid (the “curtain”) from the applicator die onto a moving surface. The die is typically a slot type die. The second suspension is fed to the curtain applicator using one or more feeding lines. The applicator can be open end, i.e. with return circulation from the applicator, or closed end, i.e. without return circulation from the applicator. The slot opening should preferably not vary by more than 1 mm, preferably not more than 500 μm, and more preferably not more than 250 μm, over the length of the slot. In some embodiments, the slot is a stratified slot whereby several layers can be deposited without mixing them. The second suspension is preferably applied on the second wire at a jet/wire speed ratio in the range of 0.8-2.5, and more preferably in the range of 0.85-2.0. The jet speed refers to the speed at which the second suspension exits the slot of the curtain applicator. The wire speed refers to the speed of the wire in the machine direction. The jet/wire speed ratio refers to the ration between the jet speed and the wire speed. A jet/wire speed ratio in the range of 0.8-2.5 and more preferably in the range of 0.85-2.0 has been found to provide optimal formation of the second web layer. The jet/wire speed ratio prevents turbulence and air inclusion and pinhole formation in the formed web layer. It also allows for the curtain to settle homogeneously and provides good curtain stability.

Before the second suspension is fed to the curtain applicator, it may preferably be subjected to mechanical deflocculation, e.g. in a hydrocyclone, a pressure screen, a stationary or rotating screener, a high shear rotor-stator mixer, or a high shear mixer. The purpose of the mechanical deflocculation is to homogenize the thick suspension and break up fiber-fibril bundles, hard gel particles, or coarse and long fibers (>4 mm in length). The screening is preferably pulsation-free screening. The mechanical deflocculation preferably comprises pressure screening.

The second suspension is applied directly on the second wire. This means that there should be no fibers or fibrous web on the wire when the second suspension is applied. The curtain may be arranged to fall onto the wire directly from the curtain applicator, or via a curtain guide. The distance between the slot of the curtain applicator or curtain guide and the dewatering fabric of the second wire is preferably in the range of 0.8-30 mm. The curtain guide may for example be a roll or an inclined metal plane which helps guide the curtain onto the second wire and or evenly distribute the second suspension on the second wire. The benefit of this is that thickness and shear can be more precisely controlled. The transfer from the curtain guide to the wire may be a non-contact or soft contact transfer.

The thickness and composition of each applied layer should be constant over the entire surface. Achieving this can be particularly difficult with wide webs.

The application of the second suspension can be made in a single deposition step or using multiple deposition steps. Application of the second suspension can for example be achieved using at least two consecutive curtain applicator units applying the same or different suspensions.

The curtain application of the second suspension can also be made using two or more curtain applicators arranged side by side. This arrangement can improve cross direction (CD) profile control. This may be especially useful for the formation of wide webs, where application using a single curtain applicator spanning the entire width of the web could lead to problems with variations in the cross direction web thickness profile. The two or more curtain applicators arranged side by side may be arranged directly side by side or they may also be displaced relative to each other in the machine direction (MD).

The water of the first and second suspensions can be removed by drainage through the first and second wire respectively, or by drying, or by a combination thereof. Dewatering of the web layers on the wires may be performed using methods and equipment known in the art. Dewatering may be one sided, i.e. only through the first and second wire respectively, or two sided, e.g. through an auxiliary wire arranged in a twin wire arrangement with the first and/or second wire respectively. Examples include blade, table and/or foil elements, suction boxes, friction less dewatering, ultra-sound assisted dewatering, couch rolls, or dandy rolls. The drainage and/or drying of the first and second suspensions results in the formation of partially dewatered web layers on the wires.

The second wire may preferably be provided with suction, such as a suction box, under the wire at the point where the curtain hits the wire, and optionally just before and/or after this point in the machine direction. This suction helps to prevent air from becoming trapped in the web or wire and helps to stabilize the curtain.

Partial dewatering means that the dry solids content of the web is increased compared to the dry solids content of the suspension, but that the dewatered web still comprises a significant amount of water. In some embodiments, partial dewatering of the wet web means that the dry solids content of the partially dewatered web is above 1 wt % but below 25 wt %. In some embodiments, partial dewatering of the wet web means that the dry solids content of the partially dewatered web is above 1.5 wt % but below 15 wt %. A dry solids content of the partially dewatered web layers in this range has been found to be especially suitable for joining the partially dewatered web layers into a multilayer web.

Since the first and second suspensions are different, and the partial dewatering of the suspensions is performed individually, the solids content of the partially dewatered first web layer and the partially dewatered second web layer may also be different. In some embodiments, the dry solids content of the partially dewatered first web layer is in the range of 1.5-15 wt %, preferably in the range of 2.5-15 wt %, and more preferably in the range of 6-15 wt %. In some embodiments, the dry solids content of the partially dewatered second web layer is in the range of 1.2-25 wt %, preferably in the range of 2.5-20 wt %, and more preferably in the range of 5-15 wt %.

The partially dewatered web layers are preferably laminated by wet lamination. When the first suspension is dewatered on the wire a visible boundary line will appear at a point where the web goes from having a reflective water layer to where this reflective layer disappears. This boundary line between the reflective and non-reflective web is referred to as the waterline. The waterline is indicative of a certain solids content, or wetness, of the web. The web layers are preferably laminated after the water line. Laminating the web layers while at least one and preferably both of the web layers are still wet ensures good adhesion between the layers. The lamination in step c) can be achieved by applying one of the partially dewatered web layers on top of the other. The surface of the web facing the wire is referred to as the wire side and the surface of the web facing away from the wire is referred to as the non-wire side. The joining may be done non-wire side against non-wire side, or wire-side against non-wire side. In some embodiments the lamination in step c) comprises laminating the partially dewatered second web layer to the non-wire side of the partially dewatered first web layer. Lamination and further dewatering of the formed multilayer web may be improved by various additional operations. In some embodiments, the lamination further comprises pressing the partially dewatered web layers together. In some embodiments, the lamination further comprises applying suction to the laminated partially dewatered web layers. Applying pressure and/or suction to the formed multilayer web improves adhesion between the web layers.

Laminating the web layers while they are still wet ensures good adhesion between the layers, while still allowing a high production speed. The inventive method provides an alternative way of increasing dewatering speed, which is less dependent on the addition of retention and drainage chemicals.

The adhesion between the web layers may be further improved by applying a bonding agent between the web layers to be joined prior to the lamination. In some embodiments, the lamination in step c) further comprises applying a bonding agent to one or both of the surfaces to be joined. The bonding agent may also improve the ply strength and mechanical properties, such as burst strength, compression strength, stiffness and puncture strength, of the cellulose-based laminate.

Furthermore, the applied bonding agent may improve runnability and reduce for example dusting. In some embodiments, the bonding agent is selected from starch, microfibrillated cellulose (MFC), nanocrystalline cellulose, or a combination thereof. In some embodiments, the bonding agent comprises a polysaccharide, preferably starch, combined with microfibrillated cellulose (MFC) or nanocrystalline cellulose. In some embodiments, the applied amount of the bonding agent is 0.2-10 gsm based on dry weight. The bonding agent may be applied at a consistency in the range of 0.2-20 wt % using any suitable coating technology, and preferably by spray coating or curtain coating.

The dry solids content of the multilayer web is typically further increased when the partially dewatered first and second web layers have been laminated. The increase in dry solids content may be due to dewatering of the multilayer web on the wire with optional pressure and/or suction applied to the laminate, and also due to drying operations performed during or shortly after the lamination, e.g. impingement drying or air or steam drying. The dry solids content of the multilayer web after lamination, or where applicable after the optional further increase of the dry solids content on the wire, is typically above 8 wt % but below 28 wt %. In some embodiments, the dry solids content of the multilayer web prior to the further dewatering and optional drying step is in the range of 8-28 wt %, preferably in the range of 10-20 wt %, and more preferably in the range of 12-18 wt %.

This type of wet lamination method allows for a multiply web comprising web layers formed from suspensions with very different compositions to be combined without mixing (or with less mixing) of the process waters of the suspensions. Dewatering of the first suspension on the first wire and the second suspension on the second wire allows for white water and reject from the different wires to be collected and recycled or reused independently of each other. This allows for the use of additives in the second suspension that are normally not used in conventional paper forming and that could potentially interfere with the wet end chemistry in the short circulation of the first suspension.

In some embodiments, the water obtained from dewatering the second web layer on the second wire is not mixed with the water obtained from dewatering the first web layer on the first wire.

Another benefit of the inventive method is that the temperature of the different suspensions and webs can be controlled and adjusted independently. It is preferred that the temperature at the point of dosing of the second suspension is in the range of 40-100° C., preferably in the range of 50-100° C., and more preferably in the range of 60-100° C., such as in the range of 62-95° C. The temperature at the point of dosing of the second suspension is preferably at least 5° C. higher, more preferably at least 10° C. higher or at least 15° C. higher, than the temperature at the point of dosing of the first suspension. By maintaining a high temperature in the second suspension, the microbial activity can be kept low and/or the viscosity of the suspension can be reduced.

The formed multilayer web is subsequently further dewatered and optionally dried to obtain a cellulose-based laminate comprising a mineral-based layer. In the dewatering and optional drying step d), the dry solids content of the multilayer web is further increased. The resulting cellulose-based laminate preferably has a dry solids content above 90 wt %.

The further dewatering typically comprises pressing the multilayer web to squeeze out as much water as possible. The further dewatering may for example include passing the formed multilayer web through a press section of a paper machine, where the web passes between large rolls loaded under high pressure to squeeze out as much water as possible. In some embodiments the further dewatering comprises passing the web through one or more shoe presses. The removed water is typically received by a fabric or felt. In some embodiments, the dry solids content of the cellulose-based laminate after the further dewatering is in the range of 15-65 wt %, preferably in the range of 18-60 wt %, and more preferably in the range of 22-55 wt %.

The optional drying may for example include drying the multilayer web by passing the multilayer web around a series of heated drying cylinders. Drying may typically reduce the water content down to a level of about 1-15 wt %, preferably to about 2-10 wt %. In some embodiments, the drying comprises drying the web on a Yankee cylinder. The Yankee cylinder can also be used to produce a glazed surface on the finished laminate.

In some embodiments the multilayer web or laminate is further subjected to smoothening by hard, soft, or super calendaring.

The dry solids content of the final cellulose-based laminate may vary depending on the intended use of the laminate. For example a laminate for use as a stand-alone product may have a dry solids content in the range of 85-99 wt %, preferably in the range of 90-98 wt %, whereas a laminate for use in further lamination to form paper or paperboard-based packaging material may have a dry solids content in the range of less than 90 wt %, preferably less than 85 wt %, such as in the range of 30-85 wt %.

The first suspension is an aqueous suspension comprising a water-suspended mixture of cellulose-based fibrous material and optionally non-fibrous additives. The cellulose-based fibrous material of the first suspension may also be referred to as “pulp”. Thus, the first suspension may preferably be a pulp suspension. The cellulose-based fibrous material, or pulp, of the first suspension can be produced from different raw materials, for example selected from the group consisting of bleached or unbleached softwood pulp or hardwood pulp, bleached or unbleached Kraft pulp, pressurized groundwood pulp (PGW), thermomechanical (TMP), chemi-thermomechanical pulp (CTMP), neutral sulfite semi chemical pulp (NSSC), broke, or recycled fibers, or combinations thereof.

The cellulose-based fibrous material of the first suspension can be unrefined or refined. Refining, or beating, of cellulose cellulose-based fibrous materials refers to mechanical treatment and modification of the cellulose fibers in order to provide them with desired properties. The cellulose-based fibrous material of the first suspension is preferably unrefined or only slightly refined, such that the cellulose-based fibrous material will have a relatively high drainage rate and low water retention. The drainage rate is expressed as a Schopper-Riegler (SR) value, as determined by standard ISO 5267-1. The cellulose-based fibrous material of the first suspension has an SR (Schopper-Riegler) value in the range of 18-50. In some embodiments, the cellulose-based fibrous material of the first suspension has an SR value in the range of 20-35. The water retention of the cellulose-based fibrous material is expressed as the water retention value (WRV), as determined by standard ISO 23714:2014. In some embodiments, the cellulose-based fibrous material of the first suspension has a water retention value (WRV) in the range of 100-220%, preferably in the range of 120-190%.

The dry solids content of the first suspension when applied to the first wire is typically in the range of 0.1-1.5 wt %, preferably in the range of 0.1-1 wt %, more preferably in the range of 0.1-0.5 wt %.

The dry solids content of the first suspension may be comprised solely of the cellulose-based fibrous material, or it can comprise a mixture of cellulose-based fibrous material and other ingredients or additives.

The first suspension preferably includes the cellulose-based fibrous material as its main component, based on the total dry weight of the suspension. In some embodiments, the first suspension comprises at least 50% by dry weight, preferably at least 70% by dry weight, more preferably at least 80% by dry weight or at least 90% by dry weight of the cellulose-based fibrous material, based on the total dry weight of the suspension.

In some embodiments, the first suspension is a Kraft pulp suspension. Refined Kraft pulp will typically comprise at least 10% by dry weight of hemicellulose. Thus, in some embodiments the first suspension comprises hemicellulose at an amount of at least 10% by dry weight, such as in the range of 10-25% by dry weight, based on the amount of the cellulose-based fibrous material.

The first suspension may further comprise additives such as native starch or starch derivatives, cellulose derivatives such as sodium carboxymethyl cellulose, a filler, retention and/or drainage chemicals, flocculation additives, deflocculating additives, dry strength additives, softeners, cross-linking aids, sizing chemicals, dyes and colorants, wet strength resins, fixatives, de-foaming aids, microbe and slime control aids, or mixtures thereof.

The first suspension preferably comprises no more than 10% by dry weight, preferably no more than 7% by dry weight, and more preferably no more than 5% by dry weight, of a particulate mineral. Particulate mineral present in the first suspension may for example come from recycled fiber or broke used as a source for the cellulose-based fibrous material.

In some embodiments, the first suspension comprises a hydrophobizing chemical such as an alkyl ketene dimer (AKD), an alkenyl succinic anhydride (ASA), or a rosin size in an amount of 0-10 kg/ton, preferably 0.1-5 kg/ton and more preferably 0.2-2 kg/ton based on the total dry weight of the suspension.

In some embodiments, the first suspension comprises unbleached pulp to give the laminate a natural look.

The Kappa number of the first web layer is typically above 30, preferably above 50, as determined according to ISO 3260.

The dry basis weight of the first web layer may generally be in the range of 10-500 gsm. In some embodiments, the dry basis weight of the first web layer is in the range of 20-400 gsm, and preferably in the range of 40-200 gsm.

The second suspension is an aqueous suspension comprising a water-suspended mixture of mineral particles, referred to herein as particulate mineral, and highly refined cellulose-based material, referred to herein as highly refined cellulose (HRC), and optionally further additives.

The second suspension comprises the particulate mineral as its main component, based on dry weight. The second suspension comprises 60-95 % by dry weight of a particulate mineral. In some embodiments, the second suspension comprises 65-95 % by dry weight, preferably 70-90 % by dry weight, of the particulate mineral.

The particulate mineral may be any particulate mineral useful in paper or paperboard manufacturing. Such particulate minerals are typically used in paper or paperboard either as fillers or as pigments, or both. In some embodiments, the particulate mineral of the second suspension is a mineral filler or a mineral pigment.

In some embodiments, the particulate mineral of the second suspension is selected from phyllosilicates (such as clay, montmorillonite, and bentonite), engineered clays (such as calcined clay), ground calcium carbonate (GCC), kaolin, precipitated calcium carbonate (PCC), talc, titanium dioxide (TiO₂), aluminum trihydrate, amorphous silicas and silicates, satin white (ettringite), zinc oxide (ZnO), and barium sulfate (BaSO₄), or a combination thereof.

In some embodiments, the particulate mineral of the second suspension is a mineral filler. In some embodiments, the mineral filler is selected from ground calcium carbonate (GCC), kaolin, precipitated calcium carbonate (PCC), talc, titanium dioxide (TiO₂), or a combination thereof.

In some embodiments, the particulate mineral of the second suspension is a mineral pigment. In some embodiments, the mineral pigment is selected from ground calcium carbonate (GCC), kaolin, precipitated calcium carbonate (PCC), talc, titanium dioxide (TiO₂), aluminum trihydrate, amorphous silicas and silicates, satin white (ettringite), zinc oxide (ZnO), and barium sulfate (BaSO₄), or a combination thereof.

The particulate mineral is preferably a platy mineral. In some embodiments, the particulate mineral has a shape factor higher than 20, preferably higher than 30, and more preferably higher than 40. “Shape factor” as used herein is a measure of an average value (on a weight average basis) of the ratio of mean particle diameter to particle thickness for a population of particles of varying size and shape, as measured using the electrical conductivity method and apparatus described in, for example, patent publications U.S. Pat. Nos. 5,128,606 and 5,576,617.

The combination of the particulate mineral with a highly refined cellulose (HRC) gives improved retention of the particulate mineral on the wire. The inventive method allows for good mineral coverage to be achieved with relatively low grammage of the mineral-based layer, such as in the range of 10-30 gsm or even 10-15 gsm, also using particulate minerals having smaller particle sizes.

The second suspension further comprises highly refined cellulose (HRC) having an SR value in the range of 75-100 as a binder. The second suspension comprises 5-40% by dry weight of the HRC. In some embodiments, the second suspension comprises 10-40% by dry weight, preferably 15-35% by dry weight, of the HRC. In other words, the dry content of the second suspension may consist entirely of the particulate mineral and the HRC, or it can comprise the particulate mineral, the HRC, and one or more additional components.

The HRC of the second suspension can be produced from wood cellulose fibers, both from hardwood and softwood fibers or a combination thereof. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

The HRC of the second suspension is more refined than the cellulose-based fibrous material of the first suspension. The drainage rate is expressed as a Schopper-Riegler (SR) value, as determined by standard ISO 5267-1. The term highly refined cellulose as used herein preferably refers to a refined cellulose-based material having a Schopper-Riegler (SR) value in the range of 75-100, as determined by standard ISO 5267-1.

The HRC of the second suspension has an SR value in the range of 75-100. In some embodiments, the HRC of the second suspension has an SR value in the range of 80-98. In some embodiments, the HRC of the second suspension has an SR value in the range of 85-98. The water retention of the HRC is expressed as the water retention value (WRV), as determined by standard ISO 23714:2014. In some embodiments, the HRC of the second suspension has a water retention value (WRV) of >200%, preferably >250%.

The HRC of the second suspension is significantly more refined than the cellulose-based fibrous material of the first suspension. More specifically, the SR value of the HRC is preferably at least 10 SR degrees, more preferably at least 20 or at least 30 SR degrees higher than the SR value of the cellulose-based fibrous material of the first suspension.

In some embodiments the highly refined cellulose is formed from a fractionated cellulose-based fibrous material from which a fraction of the finest particulate material has been removed. Such a fractionated cellulose-based fibrous material provides a highly refined cellulose having a high content of long fibrils and fibrillated fibers, whereas a large part of the smallest fibrils would have been removed. In this way, both suspension rheology and retention on the wire can be significantly improved. The content of long fibrils and fibrillated fibers in a sample can be determined using the L&W Fiber tester Plus instrument (L&W/ABB). The L&W Fiber tester Plus instrument determines the content of fibers having a length >0.2 mm (including long fibrils and fibrillated fibers having a length >0.2 mm). A known sample weight of 0.100 g is used for each sample and the content of fibers having a length >0.2 mm (million fibers per gram) is calculated using the following formula: Million fibers per gram=(No. fibers in sample)/(Sample weight)/1 000 000=(Property ID 3141)/property ID 3136)/1 000 000.

In some embodiments, the HRC of the second suspension has a content of fibers having a length >0.2 mm of at least 8 million fibers per gram based on dry weight. In some embodiments, the HRC of the second suspension has a content of fibers having a length >0.2 mm of at least 10 million fibers per gram based on dry weight, preferably at least 12 million fibers per gram based on dry weight, and more preferably at least 14 million fibers per gram based on dry weight, as determined using the L&W Fiber tester Plus instrument (L&W/ABB).

The present inventors have found that the dry solids content of the second suspension applied to the second wire should be relatively high. More specifically, the dry solids content of the second suspension when applied to the second wire should be at least 0.5 wt %. Preferably, the dry solids content of the second suspension when applied to the second wire should be significantly higher than 0.5 wt %. Without being bound to any theory, it is believed that a suspension comprising the mixture of a particulate mineral and HRC and having a high dry solids content of at least 0.5 wt % according to the present invention will reach an immobilization point faster, likely due to a relatively high amount of particles and fibrils per gram and therefore more particle-fiber, particle-particle, and fiber-fiber contact affecting the flow behavior and/or percolation network threshold. A high consistency suspension will therefore exhibit a higher wire retention than a lower consistency suspension.

In some embodiments, the second suspension has a dry solids content of at least 0.75 wt %, preferably at least 1 wt %, and more preferably at least 2 wt %.

In some embodiments, the second suspension has a dry solids content in the range of 0.75-40 wt %, preferably in the range of 1-20 wt %, and more preferably in the range of 2-15 wt %.

One advantage of the high dry solids content of the second suspension of the inventive method is the possibility that the requirement for retention or flocculation chemicals or fixatives commonly used to improve wire retention of particulate minerals and highly refined cellulose can be reduced or even eliminated.

Another benefit of the high dry solids content of the second suspension of the inventive method is that the paper machine can be run at higher speeds, or the wire be made much shorter, due to the higher solids content and less water to be removed. In some embodiments, the wires are run at speeds above 100 m/min, preferably above 200 m/min, and more preferably above 250 m/min. The wires speed typically does not exceed 1500 m/min.

Suspensions having such a high dry solids content are not suited for being applied directly to the wire in the conventional manner using a headbox. The present inventors have found that the second suspension may instead be applied using a so-called curtain applicator.

The second suspension is applied directly on the second wire. This means that there should be no fibers or fibrous web on the wire when the second suspension is applied.

The inventors have found that the second wire should preferably be wet when the second suspension is applied. Wetting the wire before the second suspension is applied initially increases drainage and can prevent the formed web from sticking to the fabric of the wire. Another benefit to add water or chemical solutions just before the wet end applicator, is that the wear of the fabric of the wire can be reduced but also that air entrapment can be eliminated or reduced. Thus, in some embodiments the second wire is subjected to treatment with steam, water, or an aqueous solution, such that the surface of the wire is wet when the second suspension is applied to the wire. The aqueous solution preferably comprises a wetting agent, a lubricant, or a humectant, or a combination thereof. Examples of wetting agents, lubricants, and humectants useful in the aqueous solution include, but are not limited to polymeric or non-polymeric surfactants, calcium stearate, sorbitol, polyethylene glycols, polyvinyl alcohols, and proteins. The amount of water or aqueous solution applied to the wire is preferably in the range of 1-10 g/m².

As mentioned, the dry content of the second suspension may consist entirely of the particulate mineral and the HRC, or it can comprise the particulate mineral, the HRC, and one or more additional components.

The second suspension comprises at least 65% by dry weight of the particulate mineral and HRC combined. In some embodiments, the second suspension comprises at least 70% by dry weight, more preferably at least 80% by dry weight or at least 90% by dry weight of the particulate mineral and HRC combined, based on the total dry weight of the suspension. In some embodiments, the second suspension comprises in the range of 50-99% by dry weight, preferably in the range of 70-99% by dry weight, more preferably in the range of 80-99% by dry weight, and more preferably in the range of 90-99% by dry weight of the particulate mineral and HRC combined, based on the total dry weight of the suspension.

In some embodiments, the particulate mineral and the HRC are co-refined, co-precipitated, and/or pre-flocculated prior to being applied to the second wire.

The HRC acts as a binder for the particulate mineral. In some embodiments, the second suspension may further comprise a co-binder. In some embodiments, the second suspension further comprises in the range of 1-10% by dry weight, preferably in the range of 3-8% by dry weight, of a co-binder.

In some embodiments, the co-binder comprises a starch, a latex, a polyhydroxyalkanoate (PHA), a polyvinyl alcohol (PVOH) or a modified cellulose. In some embodiments, the second suspension further comprises a viscosity modifier which acts to increase the viscosity of the suspension to make it more suitable for application onto the wire. In some embodiments, the second suspension further comprises in the range of 0.1-5% by dry weight, preferably in the range of 0.5-4% by dry weight, of a viscosity modifier.

The viscosity modifier may be any compound capable of increasing the viscosity of an aqueous composition. Typically, the viscosity modifier is a water soluble or water swellable, anionic, amphoteric, branched or non-ionic polymer. Examples of useful viscosity modifiers include, but are not limited to, polysaccharides or chemically modified polysaccharides, polyvinyl alcohols (PVOH), proteins, alginates, SA or SB latexes, and polyhydroxyalkanoate (PHA) emulsions.

In some embodiments, the viscosity modifier comprises a polysaccharide or a chemically modified polysaccharide. The chemical modification preferably includes at least one of cross-linking, oxidation, carboxymethylation, acetylation.

In some embodiments, the viscosity modifier comprises a natural gum, or a chemically modified natural gum. The chemical modification preferably includes at least one of cross-linking, oxidation, carboxymethylation, acetylation.

In some embodiments, the viscosity modifier is selected from the group consisting of carboxymethyl cellulose (CMC), hemicellulose, modified starch, chitosan, pectin, alginate, hydroxyl ethyl cellulose, and ethyl hydroxyethyl cellulose (EHEC). In some embodiments, the viscosity modifier is selected from the group consisting of carboxymethyl cellulose (CMC), modified starch, and ethyl hydroxyethyl cellulose (EHEC).

In some embodiments, the second suspension has a viscosity in the range of 100-100 000 mPas, preferably in the range of 200-75 000 mPas, and more preferably in the range of 250-10 000 mPas, as measured according to the SCAN-P 50:84 standard at 23° C. (also referred to as Brookfield viscosity).

In some embodiments, the second suspension has a Åbo Akademi Gravimetric Water Retention (ÅAGWR) value above 50 g/m², and preferably above 75 g/m², as determined according to Tappi T701 pm-01.

In some embodiments the second suspension comprises hemicellulose at an amount of at least 10% by dry weight, such as in the range of 10-25% by dry weight, of the amount of the HRC.

The second suspension may further comprise additives such as flocculating or deflocculating additives, dry strength additives, latexes, softeners, cross-linking aids, sizing chemicals, dyes and colorants, wet strength resins, de-foaming aids or foaming aids, microbe and slime control aids, or mixtures thereof.

The second suspension may further comprise additives that will improve different properties of the mixture and/or the produced mineral layer, such as latex and/or polyvinyl alcohol (PVOH) for enhancing the ductility of the mineral layer. The inventive method provides an alternative way of increasing dewatering speed, which is less dependent on the addition of retention and drainage chemicals, but smaller amounts of retention and drainage chemicals, preferably less than 150 g/tn and more preferably less than 50 g/tn based on the total dry weight of the second suspension, may still be used. In some embodiments, the second suspension is free from added retention and drainage chemicals.

In some embodiments, the second suspension is applied on the second wire in the form of a foam. Applying the second suspension in the form of a foam is advantageous since it allows for higher dry solids content in the suspension, than when applying it in the form of a liquid suspension. The foam density of the foamed second suspension may preferably be less than 350kg/m³, and more preferably less than 250 kg/m³. Applying the second suspension in the form of a foam is advantageous since it also enables the use of long fibrils or fibers and helps to ensure good formation and controlled fiber orientation.

The pH value of the second suspension may typically be in the range of 4-10 preferably in the range of 5-8, and more preferably in the range of 5.5-7.5.

The temperature of the second suspension may typically be in the range of 40-100° C., preferably in the range of 50-100° C., and more preferably in the range of 60-100° C.

In some embodiments, the highly refined cellulose in the second suspension comprises or consists of microfibrillated cellulose (MFC).

Microfibrillated cellulose (MFC) shall in the context of the patent application mean a cellulose particle, fiber or fibril having a width or diameter of from 20 nm to 1000 nm. Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC is produced from wood cellulose fibers, both from hardwood and softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

The second web layer preferably has a lower grammage than the first web layer. In some embodiments, the dry basis weight of the second web layer is in the range of 5-50 gsm, preferably in the range of 8-40 gsm, and more preferably in the range of 10-35 gsm. The inventive method allows for good mineral coverage to be achieved with relatively low grammage of the mineral-based layer, such as in the range of 10-30 gsm or even 10-15 gsm, also using particulate minerals having smaller particle sizes. The density of the second web layer in the formed multilayer web and laminate is typically significantly higher than the density of the corresponding first web layer. In some embodiments, the density of the second web layer in the formed multilayer web and laminate is in the range of 800-2500 kg/m³, preferably in the range of 1000-2500 kg/m³, and more preferably in the range of 1500-2500 kg/m³.

In some embodiments, the dry basis weight of the formed multilayer web and laminate is in the range of 25-500 gsm, preferably in the range of 50-400 gsm, more preferably in the range of 50-300 gsm.

In some embodiments, the density of the formed multilayer web and laminate is in the range of 800-2500 kg/m³, preferably in the range of 1000-2500 kg/m³, and more preferably in the range of 1000-2000 kg/m³.

The invention is described herein mainly with reference to an embodiment wherein the laminate is formed from two web layers. However, it is understood that the laminate may also comprise additional web layers. Thus, it is also possible that the laminate is formed from three or more web layers, such as three, four, five, six, or seven web layers.

In some embodiments, the method further comprises:
e) coating the second web layer of the obtained cellulose-based laminate with a water-soluble polymer layer.

In some embodiments, the mineral-based layer of the obtained cellulose-based laminate has an opacity value of at least 80%, preferably at least 85%, as determined according to the standard ISO 2471 (C/2°).
The Cobb-Unger value (30s) of the mineral-based layer of the obtained cellulose-based laminate is preferably less than 20 g/m², wherein the Cobb-Unger value is a measure of the oil absorption determined according to the standard SCAN-P 37:77 (30 seconds). In some embodiments, the mineral-based layer of the obtained cellulose-based laminate has a Cobb-Unger value in the range 0.5-25 g/m², preferably in the range 1-20 g/m², and more preferably in the range of 5 -15 g/m², as determined according to the standard SCAN-P 37:77 (30 seconds).

The cellulose-based laminates may be provided with a polymer layer on one side or on both sides. The polymer layer may of course interfere with repulpability but may still be required or desired in some applications. Polymer layers may for example be applied by extrusion coating, film lamination or dispersion coating.

The polymer layer may comprise any of the thermoplastic polymers commonly used in paper or paperboard-based packaging materials in general or polymers used in liquid packaging board in particular. Examples include polyethylene (PE), polyethylene terephthalate (PET), polypropylene (PP), polyhydroxyalkanoates (PHA), polylactic acid (PLA), polyglycolic acid (PGA), starch and cellulose. Polyethylenes, especially low density polyethylene (LDPE) and high density polyethylene (HDPE), are the most common and versatile polymers used in liquid packaging board.

Thermoplastic polymers are useful since they can be conveniently processed by extrusion coating techniques to form very thin and homogenous films with good liquid barrier properties. In some embodiments, the polymer layer comprises polypropylene or polyethylene. In preferred embodiments, the polymer layer comprises polyethylene, more preferably LDPE or HDPE.

The polymer layer may comprise one or more layers formed of the same polymeric resin or of different polymeric resins. In some embodiments the polymer layer comprises a mixture of two or more different polymeric resins. In some embodiments the polymer layer is a multilayer structure comprised of two or more layers, wherein a first layer is comprised of a first polymeric resin and a second layer is comprised of a second polymeric resin, which is different from the first polymeric resin.

In some embodiments, the polymer layer is formed by extrusion coating of the polymer onto a surface of the laminate. Extrusion coating is a process by which a molten plastic material is applied to a substrate to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

The basis weight of each polymer layer of the laminate is preferably less than 50 g/m². In order to achieve a continuous and substantially defect free film, a basis weight of the polymer layer of at least 8 g/m², preferably at least 12 g/m² is typically required. In some embodiments, the basis weight of the polymer layer is in the range of 8-50 g/m², preferably in the range of 12-50 g/m².

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for manufacturing a cellulose-based laminate comprising a mineral-based layer in a paper-making machine, the method comprising:
a) forming a first web layer by applying a first suspension comprising at least 50%, by dry weight, of a cellulose-based fibrous material having a Schopper-Riegler (SR) value in a range of 18-50 on a first wire, and partially dewatering the first web layer on the first wire to form a partially dewatered first web layer;
b) forming a second web layer by applying a second suspension comprising 60-95%, by dry weight, of a particulate mineral, and
5-40%, by dry weight, of a binder, wherein said binder is a highly refined cellulose (HRC) having an SR value in a range of 75-100,
on a second wire, and partially dewatering the second web layer on the second wire to form a partially dewatered second web layer,
wherein the second suspension has a dry solids content of at least 0.5 wt % and the second suspension is applied directly on the second wire using a curtain applicator;
c) laminating the partially dewatered second web layer and the partially dewatered first web layer to obtain a laminate web; and
d) dewatering, and optionally drying, the laminate web to obtain a cellulose-based laminate comprising a mineral-based layer.

2. The method according to claim 1, wherein the cellulose-based fibrous material of the first suspension has an SR value in a range of 20-35.

3. The method according to claim 1, wherein the cellulose-based fibrous material of the first suspension has a water retention value (WRV) in a range of 100-220%, as determined by standard ISO 23714:2014.

4. The method according to claim 1, wherein the second suspension comprises 65-95%, by dry weight, of the particulate mineral.

5. The method according to claim 1, wherein the particulate mineral of the second suspension is a mineral filler or a mineral pigment.

6. The method according to any claim 1, wherein the particulate mineral of the second suspension is a mineral filler selected from a group consisting of: ground calcium carbonate (GCC), kaolin, precipitated calcium carbonate (PCC), talc, titanium dioxide (TiO₂), and combinations thereof.

7. The method according to claim 1, wherein the particulate mineral of the second suspension is a mineral pigment selected from a group consisting of: ground calcium carbonate (GCC), kaolin, precipitated calcium carbonate (PCC), talc, titanium dioxide (TiO2), aluminum trihydrate, amorphous silicas and silicates, satin white (ettringite), zinc oxide (ZnO), barium sulfate (BaSO₄), and combinations thereof.

8. The method according to claim 1, wherein the second suspension comprises 10-40%, by dry weight, of the HRC.

9. The method according to claim 1, wherein the HRC of the second suspension has an SR value in a range of 80-98.

10. The method according to claim 1, wherein the HRC of the second suspension has a water retention value (WRV) of >200%, as determined by standard ISO 23714:2014.

11. (canceled)

12. The method according to claim 1, wherein the HRC of the second suspension has a content of fibers having a length >0.2 mm of at least 10 million fibers per gram based on dry weight, as determined using the L&W Fiber tester Plus instrument.

13. The method according to claim 1, wherein the particulate mineral and the HRC are co-refined, co-precipitated, pre-flocculated, or any combination thereof prior to being applied to the second wire.

14. The method according to claim 1, wherein the second suspension further comprises in a range of 1-10% by dry weight, of a co-binder.

15. (canceled)

16. The method according to claim 1, wherein the second suspension further comprises in a range of 0.1-5% by dry weight, of a viscosity modifier.

17. (canceled)

18. (canceled)

19. The method according to claim 1, wherein the second suspension has a dry solids content of at least 0.75 wt %.

20. (canceled)

21. The method according to claim 1, wherein the second suspension has a viscosity in a range of 100 to 100,000 mPas, as measured according to the SCAN-P 50:84 standard at 23° C.

22. (canceled)

23. The method according to claim 1, wherein the second suspension is applied on the second wire as a foam.

24. (canceled)

25. (canceled)

26. (canceled)

27. (canceled)

28. The method according to any claim 1, wherein a dry basis weight of the first web layer is in a range of 10-500 gsm.

29. The method according to claim 1, wherein a dry basis weight of the second web layer is in a range of 5-50 gsm.

30. The method according to claim 1, wherein a dry solids content of the partially dewatered first web layer is in a range of 1.5-15 wt %.

31. The method according to claim 1, wherein a dry solids content of the partially dewatered second web layer is in a range of 1.2-25 wt %.

32. (canceled)

33. The method according to claim 1, wherein the lamination in step c) comprises laminating the partially dewatered second web layer to a non-wire side of the partially dewatered first web layer.

34. (canceled)

35. (canceled)

36. The method according to claim 1, further comprising:
e) coating the second web layer of the obtained cellulose-based laminate with a water-soluble polymer layer.
